(19) United States
(12) Patent Application Publication
(10) Pub. No.: US 2005/0076781 A1
(43) Pub. Date: Apr. 14, 2005

(54) Desiccant dehumidifier with integrated hepa filter

(76) Inventor: Spencer W. Hess, Whiting, NJ (US)

Correspondence Address: Charles I. Brodsky, Esq., 2 Bucks Lane, Marlboro, NJ, 07746, US

(21) Appl. No.: 10/683,216

(22) Filed: Oct. 14, 2003

(51) Int. Cl. B01D 53/02

(52) U.S. Cl. 96/135

(57) ABSTRACT

Apparatus for dehumidifying moisturized air present within a building from a point external thereto including an enclosure housing a desiccant, a heat exchanger for the desiccant and a single integrated motor for drawing moisturized air through a high efficiency particulate air filter towards the heated desiccant.

### CROSS-REFERENCE TO RELATED APPLICATIONS

None.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable.

### BACKGROUND OF THE INVENTION

1. Field of the Invention

This invention relates to the restoration industry, in general, and to the drying-out of water damaged buildings, in particular.

2. Description of the Related Art

As is known and understood, mobile desiccant dehumidifiers have begun to be employed more and more in recent years to dry water damaged buildings to reduce health problems caused by the incipient mold which develops. As is also known, silica gel is oftentimes employed as the desiccant in a wheel through which the moistened air is pulled from the walls, the flooring, the concrete, etc. into the dehumidifying chamber. As the silica gel, or other desiccant employed, absorbs the moisture, however, it becomes necessary to additionally heat the desiccant to liberate the moisture it collects; this, then, serves to optimize the operation in a continuous cycle—allowing the desiccant to continually absorb the moisture in the building. Where large-scale desiccant equipment is employed, the heat energy required is oftentimes provided by electric heating or propane heating. In accordance with the teachings of my U.S. patent No. (Ser. No. 10/190,015), significant advantages follow by firing the heat exchanger with diesel fuel.

As there described, apparatus for dehumidifying moisturized air present within a building from an external point includes an enclosure housing a heat exchanger, a desiccant, a first blower drawing ambient air from outside the enclosure over the heat exchanger and through the desiccant in a first direction, and a second blower drawing the moisturized air from within the building through the desiccant in a second direction. While the apparatus there described performed perfectly well, the present invention follows from the realization that not only present within the water damaged building is moisturized air, but a myriad of air pollutants emanating from such sources as fiberglass insulation, pressed wood furniture and flooring, dust mites, lead, aerosols, pesticides, tobacco smoke, pollen, mold spores, animal hair, bacteria, Radon gas, plastics, solvents, and cleaning products just to name a few. With the apparatus typically utilized to dehumidify the water damaged building, the dried air leaving the heated desiccant is almost always pumped back into the building, and thereby just re-circulates these contaminants over and over again.

### SUMMARY OF THE INVENTION

As will become clear from the following description, the apparatus according to the invention for dehumidifying the moisturized air in this manner also includes a high energy particulate air (HEPA) filter through which the moisturized air is drawn prior to the moisturized air being passed through the heated desiccant—and, particularly, with the HEPA filter being enclosed within the same housing as a single integrated unit. Since, and as will be understood by those skilled in the art, a HEPA filter is usually powered by its own motor, integrating that motor with the one which draws in the moisturized air to begin with can be effectuated by compensating the air flow lost through the filter by increasing the rating of the included motor provided to draw in the moisturized air.

In accordance with the invention, then, the dehumidifying apparatus would include an enclosure housing the heat exchanger, the desiccant, a first blower drawing ambient air from outside the enclosure over the heat exchanger through the desiccant in a first direction, and a second blower drawing the moisturized air through the enclosure and the desiccant in a second direction. With the heat exchanger being fired in any selected manner, the further inclusion of a HEPA filter within the enclosure through which the blower draws the moisturized air prior to passing through the desiccant serves to then capture these contaminants instead of recirculating them through the water damaged building, and can be effectuated through use of a single integrated motor for drawing in the moisturized air and for filtering it.

### BRIEF DESCRIPTION OF THE DRAWINGS

These and other features of the present invention will be more clearly understood from a consideration of the following description, taken in connection with the accompanying drawings, in which:

FIG. 1 is a block diagram helpful in an understanding of apparatus for dehumidifying moisturized air present within a building from a point external thereto constructed in accordance with the invention.

### DETAILED DESCRIPTION OF THE INVENTION

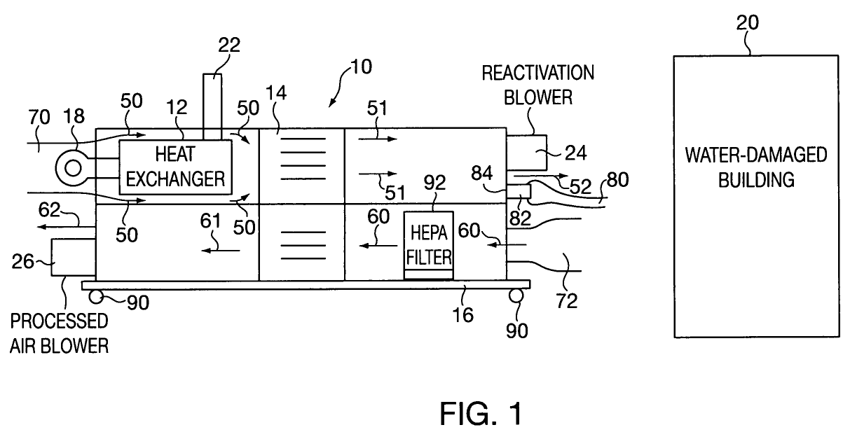

Referring to FIGS. 1 and 2, the desiccant dehumidifying apparatus follows from the use of an enclosure 10 having a heat exchanger 12 and a desiccant 14. Reference numeral 20 identifies a building in which moisturized air is present with its contaminants which the apparatus of the invention is to dehumidify, with the enclosure 10 having a bottom surface 16 which may rest upon a trailer or truck bed adjacent the building 20 once driven to the work site. Alternatively, the enclosure 10 could be off-loaded from the trailer or truck bed onto the ground itself—and in one embodiment of the invention includes a pair of support wheels 90 for moving the enclosure about. Reference numeral 18 indicates a fuel burner having an exhaust gas stack 22, with the fuel burner 18 heating the exchanger 12 from the inside out. As with my above-cited patent, the fuel burner 18 could fire the exchanger with diesel fuel, although the teachings of the invention apply equally as well where electric heating or propane heating is utilized to reactivate the desiccant.

A first, or reactivation blower 24 draws ambient air from the surrounds via ductwork 70 into the enclosure 10, over and about the heat exchanger 12 and through the desiccant 14 in a first direction, as illustrated by the arrows 50. A second, or processed air, blower 26 draws the moisturized air from within the building through ductwork 72 and the desiccant 14 in a second direction (shown by the arrows 60), which traps the moisture therein before discharging the dried air out the enclosure 10 as shown by the arrows 61-62. The moisture liberated, heated air through the desiccant 14 is discharged outside the enclosure 10 as shown by the arrows 51-52. The heat exchanger 10 thus dehumidifies the desiccant 14 of the moisture collected from the wet building air in reactivating the desiccant 14 for continuing use. At the same time, the dried air from the enclosure 10 is blown or pumped along the arrows 51-52 back into the building 20.

In the embodiment depicted in FIG. 1, the ambient air from outside the enclosure 10 is shown as being drawn through the desiccant 14 in a direction opposite to that in which the moisturized air is pulled from the building through the desiccant 14. In typical manner of use, the heated dried air exiting through the desiccant 14 is returned to the building by means of an outlet port 84 of the enclosure 10, a duct 82, and a hose 80 clamped in place over the duct 82.

While the dried air is thus pumped back into the building, the contaminants which are present in the moisturized air are pumped back as well—albeit now somewhat heated and dried. Such contaminants, however, are substantially eliminated according to the present invention by incorporating within the enclosure 10 a separate high efficiency particulate air (HEPA) filter 92 through which the moisturized air is first drawn on its way towards the heated desiccant 14. Rather than the HEPA filter being provided as a separate unit whose input is ducted to the building 20 and whose output is then ducted to the enclosure 10 (and requiring its own motor), the inclusion of the filter within the enclosure 10 allows for a single motor (or blower) to be utilized both in drawing the moisturized air through the filter and through the desiccant 14. Because there may be an air flow loss through the HEPA filter, the rating of the included motor (shown as the blower 26) would generally be increased to compensate entirely for the loss, or to such an amount as to substantially offset it. A single unitary housing thus results, which can be moved about more easily when on support wheels, than if a separate HEPA filter were employed. A smaller, dehumidifying apparatus follows by eliminating the need for a separate filtering motor—which, as with that of my afore cited patent, then provides an improved environmental air-drawing quickly, simply and efficiently, thereby reducing the severe health problems associated with water damaged buildings. With the teachings of the present invention, a purification of upwards of 99%+ of airborne contaminants could be provided through the scrubbing effect of the HEPA type of air purification systems available, as well as the desired dehumidification.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the scope of the invention.

1. In dehumidifying apparatus drawing moisturized air from a building through a heated desiccant within a housing, and by blowing dried air back, the improvement comprising, the addition of a high efficient particulate air filter through which said moisturized air is drawn prior to said moisturized air being drawn through said heated desiccant, and with said high efficiency particulate air filter being enclosed within said housing as a single integrated unit.

2. The improvement of claim 1 wherein air flow loss through said high efficiency particulate air filter is compensated for by increasing the rating of an included motor provided to draw said moisturized air from said building through said heated desiccant.

3. The improvement of claim 1 wherein air flow loss through said high efficiency particulate air filter is substantially offset by increasing the rating of an included motor provided to draw said moisturized air from said building through said heated desiccant.

4. The improvement of claim 1 wherein air flow loss through said high efficiency particulate air filter is compensated for by increasing the rating of a single included motor provided to draw said moisturized air from said building through said heated desiccant.

5. The improvement of claim 1 wherein air flow loss through said high efficiency particulate air filter is substantially offset by increasing the rating of a single included motor provided to draw said moisturized air from said building through said heated desiccant.

6. Apparatus for dehumidifying moisturized air present within a building from a point external thereto comprising: an enclosure housing a heat exchanger, a desiccant, a first blower drawing ambient air from outside said enclosure over said heat exchanger through said desiccant in a first direction, a second blower drawing said moisturized air through said enclosure and said desiccant in a second direction, means for firing said heat exchanger, and a high efficiency particulate air filter through which said second blower draws said moisturized air towards said desiccant, and with said second blower including a single integrated motor.

7. The apparatus of claim 6 wherein said enclosure rests on a ground surface adjacent said building in which said moisturized air is present.

8. The apparatus of claim 6 wherein said unitary enclosure rests on a ground trailer or truck bed adjacent said building in which said moisturized air is present.

9. The apparatus of claim 8 wherein said unitary enclosure includes support wheels for moving said enclosure about.

10. The apparatus of claim 6 wherein said means fires said heat exchanger with diesel fuel.
